(19) United States
(12) Patent Application Publication
(10) Pub. No.: US 2022/0190465 A1
(43) Pub. Date: Jun. 16, 2022

(54) MOBILE DEVICE

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 17/204,109

(22) Filed: Mar. 17, 2021

(30) Foreign Application Priority Data
Dec. 10, 2020 (TW) 109143608

(51) Int. Cl. H01Q 1/24; H01Q 21/00; H01Q 5/50

(52) U.S. Cl. CPC H01Q 1/243; H01Q 5/50; H01Q 21/0025

(57) ABSTRACT

A mobile device includes a first radiation element, a second radiation element, a third radiation element, a fourth radiation element, a fifth radiation element, a sixth radiation element, and a dielectric substrate. The first radiation element has a feeding point. The second radiation element is coupled to a ground voltage. The third radiation element has a meandering shape. The fourth radiation element is adjacent to the first radiation element. The fourth radiation element is coupled through the third radiation element to the second radiation element. The fifth radiation element is coupled to the second radiation element. The sixth radiation element is coupled to the second radiation element. An antenna structure is formed by the first radiation element, the second radiation element, the third radiation element, the fourth radiation element, the fifth radiation element, and the sixth radiation element.

### CROSS REFERENCE TO RELATED APPLICATIONS

This application claims priority of Taiwan Patent Application No. 109143608 filed on Dec. 10, 2020, the entirety of which is incorporated by reference herein.

### BACKGROUND OF THE INVENTION

### Field of the Invention

The disclosure generally relates to a mobile device, and more particularly, it relates to a mobile device and an antenna structure therein.

### Description of the Related Art

With the advancements being made in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, 2500 MHz, and 2700 MHz. Some devices cover a small wireless communication area; these include mobile phones using Wi-Fi and Bluetooth systems and using frequency bands of 2.4 GHz, 5.2 GHz, and 5.8 GHz.

Antennas are indispensable elements for wireless communication. However, antennas tend to be affected by nearby metal elements. When antennas experience interference, overall communication quality may become degraded, and the SAR (Specific Absorption Rate) may exceed legal limits. Accordingly, there is a need to propose a novel solution for solving the problems of the prior art.

### BRIEF SUMMARY OF THE INVENTION

In an exemplary embodiment, the disclosure is directed to a mobile device that includes a first radiation element, a second radiation element, a third radiation element, a fourth radiation element, a fifth radiation element, a sixth radiation element, and a dielectric substrate. The first radiation element has a feeding point. The second radiation element is coupled to a ground voltage. The third radiation element has a meandering shape. The fourth radiation element is adjacent to the first radiation element. The fourth radiation element is coupled through the third radiation element to the second radiation element. The fifth radiation element is coupled to the second radiation element. The fifth radiation element and the fourth radiation element substantially extend in the same direction. The sixth radiation element is coupled to the second radiation element. The first radiation element, the second radiation element, the third radiation element, the fourth radiation element, the fifth radiation element, and the sixth radiation element are disposed on the dielectric substrate. An antenna structure is formed by the first radiation element, the second radiation element, the third radiation element, the fourth radiation element, the fifth radiation element, and the sixth radiation element.

In some embodiments, the first radiation element substantially has an L-shape.

In some embodiments, the second radiation element includes a wide portion and a narrow portion which are substantially perpendicular to each other. The wide portion of the second radiation element is coupled to the ground voltage.

In some embodiments, the third radiation element substantially has a U-shape.

In some embodiments, the length of the fourth radiation element is substantially equal to the length of the second radiation element.

In some embodiments, a coupling gap is formed between the fourth radiation element and the first radiation element.

In some embodiments, the antenna structure covers a first frequency band and a second frequency band. The first frequency band is from 2400 MHz to 2500 MHz. The second frequency band is from 5150 MHz to 5850 MHz.

In some embodiments, in the second frequency band, the maximum current density of the antenna structure is positioned at the third radiation element.

In some embodiments, the length of the first radiation element is substantially equal to 0.25 wavelength of the second frequency band.

In some embodiments, the total length of the second radiation element, the third radiation element, and the fourth radiation element is substantially equal to 0.25 wavelength of the first frequency band.

### BRIEF DESCRIPTION OF DRAWINGS

The invention can be more fully understood by reading the subsequent detailed description and examples with references made to the accompanying drawings, wherein:

FIG. 1 is a top view of a mobile device according to an embodiment of the invention;

FIG. 2 is a diagram of radiation efficiency of an antenna structure of a mobile device according to an embodiment of the invention;

FIG. 3A is a view of a convertible mobile device operating in a notebook mode according to an embodiment of the invention;

FIG. 3B is a view of a convertible mobile device operating in a tablet mode according to an embodiment of the invention; and

FIG. 4 is a partial sectional view of a convertible mobile device according to an embodiment of the invention.

### DETAILED DESCRIPTION OF THE INVENTION

In order to illustrate the purposes, features and advantages of the invention, the embodiments and figures of the invention are shown in detail below.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

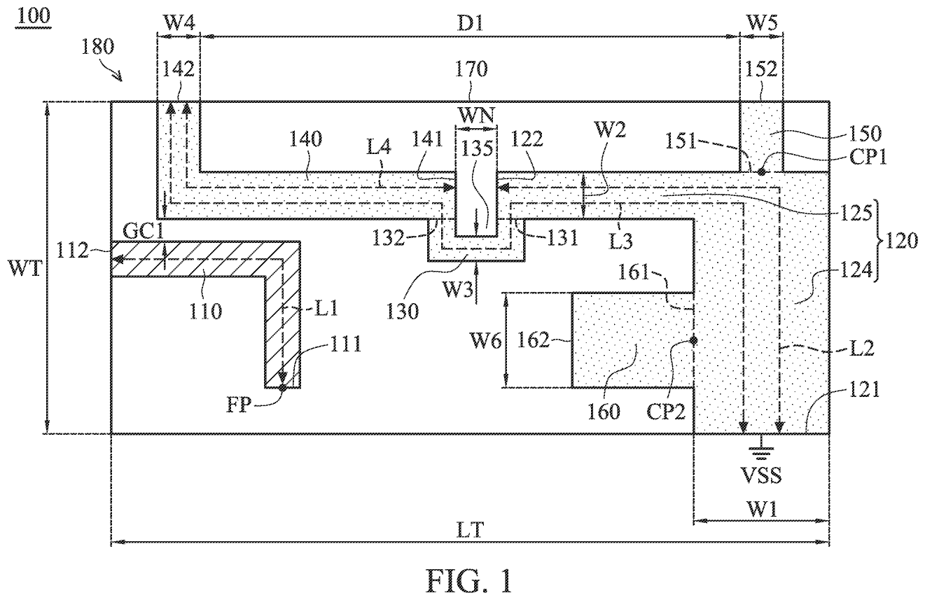

FIG. 1 is a top view of a mobile device 100 according to an embodiment of the invention. For example, the mobile device 100 may be a smartphone, a tablet computer, or a notebook computer. As shown in FIG. 1, the mobile device 100 includes a first radiation element 110, a second radiation element 120, a third radiation element 130, a fourth radiation element 140, a fifth radiation element 150, a sixth radiation element 160, and a dielectric substrate 170. The first radiation element 110, the second radiation element 120, the third radiation element 130, the fourth radiation element 140, the fifth radiation element 150, and the sixth radiation element 160 may all be made of metal materials, such as copper, silver, aluminum, iron, or an alloy thereof. It should be understood that the mobile device 100 may further include other components, such as a display device, a speaker, a touch control module, a power supply module, and a housing, although they are not displayed in FIG. 1.

The first radiation element 110 may substantially has an L-shape. Specifically, the first radiation element 110 has a first end 111 and a second end 112. A feeding point FP is positioned at the first end 111 of the first radiation element 110. The second end 112 of the first radiation element 110 is an open end. The feeding point FP may be further coupled to a signal source (not shown). For example, the signal source may be an RF (Radio Frequency) module.

The second radiation element 120 may substantially has a variable-width L-shape. Specifically, the second radiation element 120 has a first end 121 and a second end 122. The first end 121 of the second radiation element 120 is coupled to the ground voltage VSS. For example, the ground voltage VSS may be provided by a system ground plane or a ground copper foil coupled thereto (not shown). In some embodiments, the second radiation element 120 includes a wide portion 124 and a narrow portion 125 which are substantially perpendicular to each other. The wide portion 124 of the second radiation element 120 is coupled to the ground voltage VSS.

The third radiation element 130 may substantially have a meandering shape, such as a U-shape with a notch region 135. Specifically, the third radiation element 130 has a first end 131 and a second end 132. The first end 131 of the third radiation element 130 is coupled to the second end 122 or the narrow portion 125 of the second radiation element 120. However, the invention is not limited thereto. In alternative embodiments, the meandering shape of the third radiation element 130 is a W-shape or an M-shape.

The fourth radiation element 140 may substantially have an L-shape. Specifically, the fourth radiation element 140 has a first end 141 and a second end 142. The first end 141 of the fourth radiation element 140 is coupled to the second end 132 of the third radiation element 130. The second end 142 of the fourth radiation element 140 is an open end. Generally, the fourth radiation element 140 is coupled through the third radiation element 130 to the second radiation element 120. Furthermore, the fourth radiation element 140 is adjacent to the first radiation element 110, such that a coupling gap GC1 is formed between the fourth radiation element 140 and the first radiation element 110. It should be noted that the term “adjacent” or “close” over the disclosure means that the distance (the space) between two corresponding elements is smaller than a predetermined distance (e.g., 5 mm or shorter), but often does not mean that the two corresponding elements are touching each other directly (i.e., the aforementioned distance or space therebetween is reduced to 0).

The fifth radiation element 150 may substantially have a relatively narrow straight-line shape. Specifically, the fifth radiation element 150 has a first end 151 and a second end 152. The first end 151 of the fifth radiation element 150 is coupled to a first connection point CP1 on the narrow portion 125 of the second radiation element 120. The second end 152 of the fifth radiation element 150 is an open end. In some embodiments, the second end 152 of the fifth radiation element 150 and the second end 142 of the fourth radiation element 140 substantially extend in the same direction.

The sixth radiation element 160 may substantially have a relatively wide straight-line shape (compared with the fifth radiation element 150). Specifically, the sixth radiation element 160 has a first end 161 and a second end 162. The first end 161 of the sixth radiation element 160 is coupled to a second connection point CP2 on the wide portion 124 of the second radiation element 120. The second end 162 of the sixth radiation element 160 is an open end. In some embodiments, the second end 162 of the sixth radiation element 160 and the second end 112 of the first radiation element 110 substantially extend in the same direction.

The dielectric substrate 170 may be an FR4 (Flame Retardant 4) substrate, a PCB (Printed Circuit Board), or an FPC (Flexible Printed Circuit Board), but it is not limited thereto. The first radiation element 110, the second radiation element 120, the third radiation element 130, the fourth radiation element 140, the fifth radiation element 150, and the sixth radiation element 160 may all be disposed on the same surface of the dielectric substrate 170.

In a preferred embodiment, an antenna structure 180 of the mobile device 100 is formed by the first radiation element 110, the second radiation element 120, the third radiation element 130, the fourth radiation element 140, the fifth radiation element 150, and the sixth radiation element 160, and it can belong a planar coupled-fed antenna.

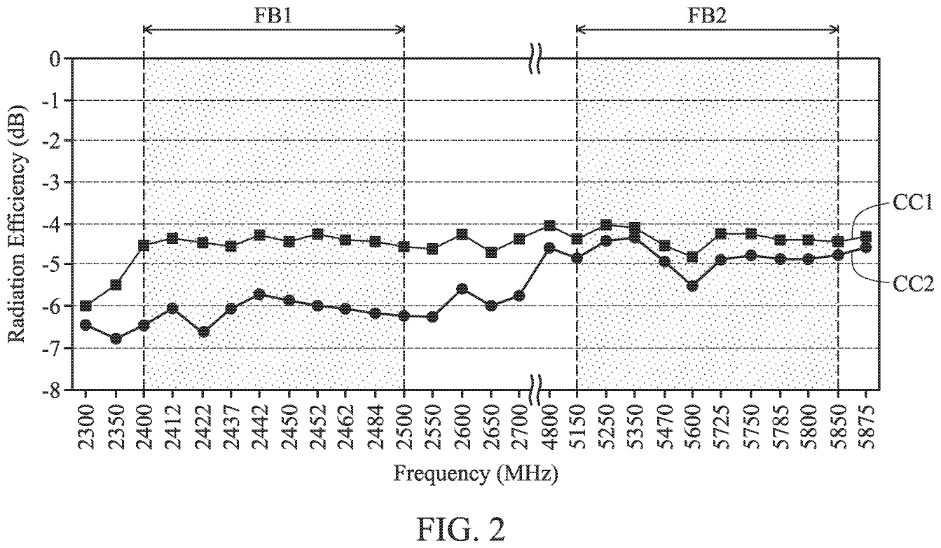

FIG. 2 is a diagram of radiation efficiency of the antenna structure 180 of the mobile device 100 according to an embodiment of the invention. The horizontal axis represents the operation frequency (MHz), and the vertical axis represents the radiation efficiency (dB). A first curve CC1 corresponds to the antenna radiation characteristic of the mobile device 100 operating in a notebook mode. A second curve CC2 corresponds to the antenna radiation characteristic of the mobile device 100 operating in a tablet mode. According to the measurement of FIG. 2, regardless of the notebook mode or the tablet mode, the antenna structure 180 of the mobile device 100 can cover a first frequency band FB1 and a second frequency band FB2. For example, the first frequency band FB1 may be from 2400 MHz to 2500 MHz, and the second frequency band FB2 may be from 5150 MHz to 5850 MHz. Therefore, the antenna structure 180 of the mobile device 100 can support at least the wideband operations of WLAN (Wireless Local Area Networks) 2.4 GHz/5 GHz.

In some embodiments, the operation principles of the mobile device 100 and the antenna structure 180 therein are described as follows. The first radiation element 110 can be excited independently, so as to generate the second frequency band FB2. The second radiation element 120, the third radiation element 130, and the fourth radiation element 140 can be excited by the first radiation element 110 using a coupling mechanism, so as to generate the first frequency band FB1. It should be noted that in the second frequency band FB2, the maximum current density of the antenna structure 180 is positioned at the third radiation element 130. According to practical measurements, such a design can make the antenna structure 180 pass the test criterion of SAR (Specific Absorption Rate). In addition, the wide portion 124 of the second radiation element 120 can fine-tune the impedance matching of the first frequency band FB1. The incorporation of the fifth radiation element 150 and the sixth radiation element 160 can increase the operation bandwidth of the first frequency band FB1.

In some embodiments, the element sizes of the mobile device 100 and its antenna structure 180 are described as follows. The length L1 of the first radiation element 110 may be substantially equal to 0.25 wavelength (λ/4) of the second frequency band FB2 of the antenna structure 180. The length L4 of the fourth radiation element 140 may be substantially equal to the length L2 of the second radiation element 120. That is, the third radiation element 130 may be positioned at the central point between the second radiation element 120 and the fourth radiation element 140. The total length L3 of the second radiation element 120, the third radiation element 130, and the fourth radiation element 140 may be substantially equal to 0.25 wavelength (λ/4) of the first frequency band FB1 of the antenna structure 180. In the second radiation element 120, the width W1 of the wide portion 124 may be from 5 mm to 7 mm, and the width W2 of the narrow portion 125 may be from 2 mm to 3 mm. The width W3 of the third radiation element 130 may be smaller than the width W4 of the fourth radiation element 140, and may also be smaller than the width W5 of the fifth radiation element 150. The width WN of the notch region 135 of the third radiation element 130 may be from 0.5 mm to 1.5 mm. The distance D1 between the second end 142 of the fourth radiation element 140 and the second end 152 of the fifth radiation element 150 may be from 15 mm to 18 mm. The total length LT of the antenna structure 180 may be from 20 mm to 25 mm. The total width WT of the antenna structure 180 may be from 8 mm to 10 mm. The above ranges of element sizes are calculated and obtained according to many experiment results, and they help to optimize the operation bandwidth and impedance matching of the antenna structure 180 and to minimize the SAR of the antenna structure 180.

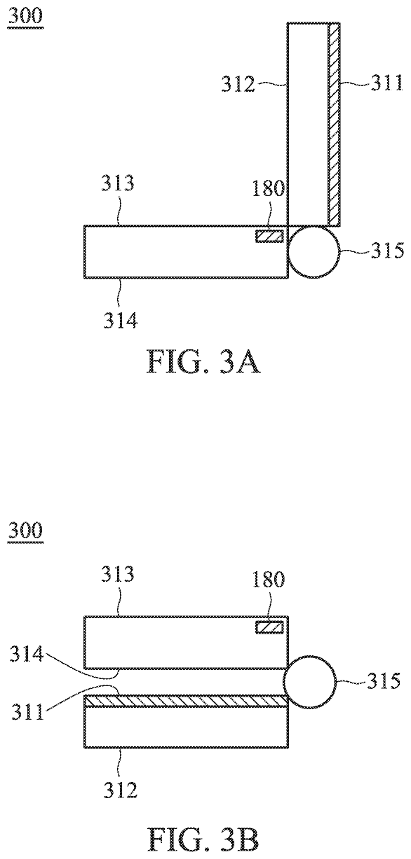

FIG. 3A is a view of a convertible mobile device 300 operating in a notebook mode according to an embodiment of the invention. FIG. 3B is a view of the convertible mobile device 300 operating in a tablet mode according to an embodiment of the invention. The proposed antenna structure 180 may be applied to the convertible mobile device 300, which may include a metal back cover 311, a display frame 312, a keyboard frame 313, a base housing 314, and a hinge element 315. It should be understood that the metal back cover 311, the display frame 312, the keyboard frame 313, and the base housing 314 are equivalent to the so-called “A-component”, “B-component”, “C-component”, and “D-component” in the field of notebook computers, respectively. The proposed antenna structure 180 can be disposed inside the internal space between the keyboard frame 313 and the base housing 314. The keyboard frame 313 and the base housing 314 may be made of nonconductive materials.

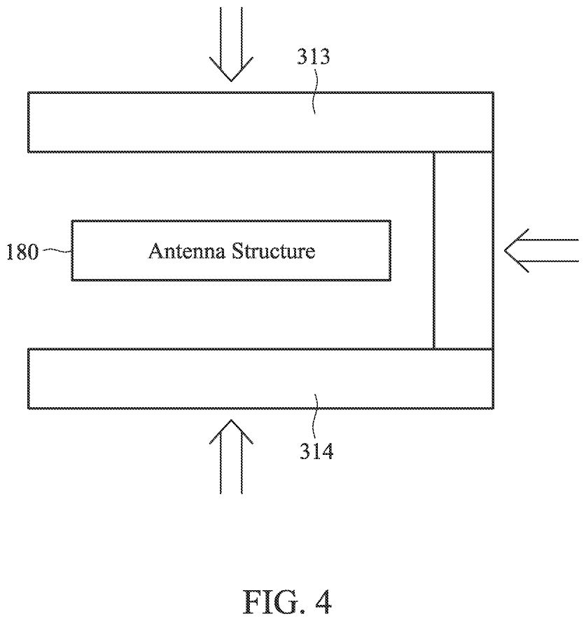

FIG. 4 is a partial sectional view of the convertible mobile device 300 according to an embodiment of the invention. The arrows of FIG. 4 represent the probing directions of SAR tests. According to practical measurements, the SAR relative to the antenna structure 180 of the convertible mobile device 300 operating in the notebook mode can be reduced by about 54.5%, and the SAR relative to the antenna structure 180 of the convertible mobile device 300 operating in the tablet mode can be reduced by about 62.5%. It can meet the requirement of practical application of general mobile communication devices.

The invention proposes a mobile device and a novel antenna structure therein, which can cover WLAN frequency bands and reduce the original SAR by 50% or more. In comparison to the conventional design, the invention has at least the advantages of small size, low SAR, wide bandwidth, and low manufacturing cost, and therefore it is suitable for application in a variety of mobile communication devices.

Note that the above element sizes, element shapes, and frequency ranges are not limitations of the invention. An antenna designer can fine-tune these settings or values according to different requirements. It should be understood that the mobile device and antenna structure of the invention are not limited to the configurations of FIGS. 1-4. The invention may merely include any one or more features of any one or more embodiments of FIGS. 1-4. In other words, not all of the features displayed in the figures should be implemented in the mobile device and antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device, comprising:
a first radiation element, having a feeding point;
a second radiation element, coupled to a ground voltage;
a third radiation element, having a meandering shape;
a fourth radiation element, disposed adjacent to the first radiation element, wherein the fourth radiation element is coupled through the third radiation element to the second radiation element;
a fifth radiation element, coupled to the second radiation element, wherein the fifth radiation element and the fourth radiation element substantially extend in a same direction;
a sixth radiation element, coupled to the second radiation element; and
a dielectric substrate, wherein the first radiation element, the second radiation element, the third radiation element, the fourth radiation element, the fifth radiation element, and the sixth radiation element are disposed on the dielectric substrate;
wherein an antenna structure is formed by the first radiation element, the second radiation element, the third radiation element, the fourth radiation element, the fifth radiation element, and the sixth radiation element.

2. The mobile device as claimed in claim 1, wherein the first radiation element substantially has an L-shape.

3. The mobile device as claimed in claim 1, wherein the antenna structure is a planar coupled-fed antenna.

4. The mobile device as claimed in claim 1, wherein the second radiation element comprises a wide portion and a narrow portion.

5. The mobile device as claimed in claim 4, wherein the wide portion and the narrow portion of the second radiation element are substantially perpendicular to each other.

6. The mobile device as claimed in claim 4, wherein the wide portion of the second radiation element is coupled to the ground voltage.

7. The mobile device as claimed in claim 1, wherein the third radiation element substantially has a U-shape.

8. The mobile device as claimed in claim 1, wherein a length of the fourth radiation element is substantially equal to a length of the second radiation element.

9. The mobile device as claimed in claim 1, wherein a coupling gap is formed between the fourth radiation element and the first radiation element.

10. The mobile device as claimed in claim 1, wherein the antenna structure covers a first frequency band and a second frequency band.

11. The mobile device as claimed in claim 10, wherein the first frequency band is from 2400 MHz to 2500 MHz.

12. The mobile device as claimed in claim 10, wherein the second frequency band is from 5150 MHz to 5850 MHz.

13. The mobile device as claimed in claim 10, wherein in the second frequency band, a maximum current density of the antenna structure is positioned at the third radiation element.

14. The mobile device as claimed in claim 10, wherein a length of the first radiation element is substantially equal to 0.25 wavelength of the second frequency band.

15. The mobile device as claimed in claim 10, wherein a total length of the second radiation element, the third radiation element, and the fourth radiation element is substantially equal to 0.25 wavelength of the first frequency band.
